(19) United States
(12) Patent Application Publication
(10) Pub. No.: US 2005/0245665 A1
(43) Pub. Date: Nov. 3, 2005

(54) Method of forming nanocomposite materials

(76) Inventor: Chenggang Chen, Beavercreek, OH (US)

Correspondence Address: DINSMORE & SHOHL LLP;Suite 1300, One Dayton Centre, One South Main Street, Dayton, OH, 45402-2023, US

(21) Appl. No.: 11/134,886

(22) Filed: May 23, 2005

Related U.S. Application Data
(63) Continuation-in-part of application No. 10/789,295, filed on Feb. 27, 2004.
Application No. 10/789,295 is a continuation-in-part of application No. 10/698,218, filed on Oct. 31, 2003.
Application No. 10/698,218 is a division of application No. 09/932,169, filed on Aug. 17, 2001, now Pat. No. 6,680,016.

(51) Int. Cl. C08K 3/34

(52) U.S. Cl. 524/493

(57) ABSTRACT

A method of making a nanocomposite having homogeneously dispersed individual nanosize spherical silica particles. The invention also involves a method of making a nancomposite having homogeneously dispersed small aggregated nanosize spherical silica particles.

### CROSS REFERENCE TO RELATED APPLICATIONS

This application is a continuation-in-part of U.S. patent application Ser. No. ______ filed on even date herewith, entitled “Method of Forming Nanocomposite Materials,” (Attorney Docket Number UVD 0307 I2), which is a continuation-in-part of U.S. patent application Ser. No. 10/789,295, filed Feb. 27, 2004, which is a continuation-in-part of U.S. patent application Ser. No. 10/698,218, filed Oct. 31, 2003, which is a division of U.S. patent application Ser. No. 09/932,169, filed Aug. 17, 2001, now U.S. Pat. No. 6,680,016.

### BACKGROUND OF THE INVENTION

The present invention is directed to a nanocomposite material incorporating uniformly dispersed nanosize materials, and to a method of forming such a nanocomposite material.

It is known that nanosize materials may be used to enhance the mechanical, electronic and thermal transport properties of polymers and other high-performance plastics for use in a variety of applications. For example, vapor-grown carbon nanofibers have been dispersed in polymer matrices by a polymer melt blending method in which the dispersants in the polymer matrix are mechanically sheared apart. See, for example, U.S. Pat. No. 5,643,502. As nanosize materials tend to clump together, this reduces the benefit of their properties when they are incorporated into the polymer matrix. And, as most polymers are incompatible with nanosize materials, it is difficult to achieve uniform dispersion of the materials in the polymer matrix.

Accordingly, there is still a need in the art for an improved method of reinforcing a polymeric material with nanosize materials such as spherical silica which provides a uniform dispersion of the nanosize materials in the polymer matrix and which produces a nanocomposite material having improvement in various mechanical, electrical, and thermal properties.

### SUMMARY OF THE INVENTION

The present invention meets this need by providing a method of making a nanocomposite having individual nanosize spherical silica particles. The method includes providing a suspension of nanosize spherical silica particles in solvent; combining the suspension of nanosize spherical silica particles and a polymer to form a substantially homogeneous mixture; adding a curing agent to the mixture; removing the solvent from the mixture; and curing the mixture to form the nanocomposite, wherein the nanocomposite comprises the individual nanosize spherical silica particles dispersed in the polymer. As is well understood, by polymers, we mean that they also include monomers and other polymer precursors which will form polymers later.

Another aspect of the invention is a method of making a nanocomposite having uniform aggregated nanosize spherical silica particles. The method includes providing nanosize spherical silica particles; combining the nanosize spherical silica particles and a polymer with solvent using high shear mixing to form a substantially homogeneous mixture; removing the solvent from the mixture; adding a curing agent to the mixture; and curing the mixture to form the nanocomposite, wherein the nanocomposite comprises small aggregated nanosize spherical silica particles homogeneously dispersed in the polymer.

### BRIEF DESCRIPTION OF THE DRAWINGS

FIG. 1 are TEM images of a nanocomposite containing 1.3 wt % spherical silica (powder from Aldrich), epoxy resin (Epon 862), and curing agent (curing agent W) made using the stir-bar mixing.

FIG. 2 shows the ultra-small-angle x-ray scattering of the nanocomposites of FIG. 1.

FIG. 3 are TEM images of a nanocomposite containing 1 wt % spherical silica (powder from Aldrich), epoxy resin (Epon 862), and curing agent (curing agent W) made using high-shear mixing.

FIG. 4 shows the ultra-small-angle x-ray scattering of the nanocomposites of FIG. 3.

FIG. 5 are TEM images of a nanocomposite containing 1.3 wt % spherical silica (powder from Aldrich), epoxy resin (Epon 862), and curing agent (curing agent W) made using high-shear mixing and ultrasonication.

FIG. 6 shows the ultra-small-angle x-ray scattering of nanocomposites of FIG. 5. The solid line is the unified fit for the data.

FIG. 7 are TEM images of a nanocomposite containing 1.3 wt % spherical silica (powder from Aldrich), epoxy resin (Epon 828), and curing agent (curing agent W) made using high-shear mixing and ultrasonication.

FIG. 8 are TEM images of a nanocomposite containing 1.1 wt % spherical silica (powder from Aldrich), epoxy resin (Epon 828), and curing agent (Jeffamine D400) made using high-shear mixing and ultrasonication.

FIG. 9 are TEM images of a nanocomposite containing 1.3 wt % spherical silica (MEK-ST suspension from Nissan Chemicals), epoxy (Epon 862), and curing agent (curing agent W) made using stir bar mixing and ultrasonication.

FIG. 10 shows the ultra-small-angle x-ray scattering of the nanocomposites of FIG. 9. The solid line is the unified fit for the data.

### DETAILED DESCRIPTION OF THE INVENTION

The invention allows control of the morphology of a dispersion of nanosize spherical silica in a nanocomposite. Nanocomposites having individual nanosize spherical silica particles dispersed in the polymer, or small aggregated nanosize spherical silica particles dispersed in the polymer can be obtained. By “small aggregated nanosize spherical silica particles,” we mean aggregated silica particles with a dimension less than about 500 nm, generally less than about 400 nm. The aggregated nanosize spherical silica particles are typically in the range of about 30 nm to about 200 nm, or about 50 nm to about 120 nm, or about 60 nm to about 120 nm. The small aggregated particles typically contain about 5 to about 10 individual spherical silica nanoparticles.

The methods of the present invention achieve uniform dispersion of nanosize spherical silica in polymer matrices. We have found that these methods are more effective in uniformly dispersing nanosize materials into polymer matrices than prior art methods such as melt blending. By “uniformly dispersed,” we mean that the nanosize materials are uniformly dispersed throughout the polymer matrix. Accordingly, the nanosize spherical silica is combined with the polymer to form a substantially homogeneous mixture. By “substantially homogeneous mixture,” we mean that the nanosize spherical silica is uniformly dispersed in the solution mixture. The curing agent is then added, and the mixture is cured.

The resulting polymer nanocomposite material can be further processed into various shapes and forms by conventional polymer extrusion and molding techniques.

Some of the methods of the present invention provide another advantage over prior melt-blending processes in that they utilize a low-temperature solution process, (i.e., no heat is required to melt the polymer) to disperse the nanosize materials.

Suitable polymers for use in the present invention include various thermosetting polymers. Any thermosetting polymer may be used in the present invention as long as the polymer precursor or monomer is soluble in a solvent. Suitable polymers include, but are not limited to, epoxies, cyanaster esters, polyimides, polybenzoxanes, phenolics, or combinations thereof. Suitable epoxy resins include Epon 862 or Epon 828, commercially available from Shell Chemical Co. The polymer is generally present in a concentration of at least about 80 wt %, typically about 90 to about 99 wt %. It should be appreciated that the concentration of the polymer may vary depending on the desired properties and applications, such as coatings, of the resulting composite material.

Suitable nanosize spherical silica for use in the present invention is commercially available from Aldrich (fumed silica powder) and Nissan Chemicals (MEK-ST, suspension). When a nanocomposite with individual nanosize spherical silica is desired, it is desirable to use MEK-ST available from Nissan Chemicals which is a suspension of about 30 wt % silica in about 70 wt % solvent (methylethyl ketone). The nanosize spherical silica can be present in an amount up to about 20 wt % or more in the final product, typically about 1 to about 10 wt %. A concentrate containing a higher weight percentage of silica could be prepared, and the concentrate could then be diluted with polymer to form the final desired product.

Generally, a curing agent is added to cure the resin after the solvent has been removed from the mixture. Removing the solvent before the curing agent is added is advantageous because no particular limits apply to its removal at that time. However, it can be removed after the curing agent has been added, if desired. This is less desirable because curing rate affects the solvent removal. The solvent would have to be removed before the viscosity becomes too high, which would vary depending on the polymer, the curing agent, and the amounts of the various components, making control of the process more difficult.

Suitable curing agents for use in the present invention include, but are not limited to, amines, and anhydrides. Suitable amines include, but are not limited to, multi-functional amines. Suitable curing agents include, but are not limited to, diethyltoluenediamine (available from Shell); Jeffamine® curing agents (such as D230, D400, D2000, and T403) available from Huntsman Chemical; diethyltriamine; triethyltetramine; 4,4′-diaminodiphenylmethane; 1,3-phenyldiamine; polyaminoamide; and nadic methyl anhydride. 4-aminophenyl sulfone and 3-aminophenyl sulfone are desirable amine curing agents because epoxies made using them have a very high Tg after cure.

An accelerator may optionally be included. The accelerators can be weak bases, such as tertiary arnines (for example, benzyldimethylamine), and imidazole derivatives.

An optional coupling agent may also be added. Suitable coupling agents include, but are not limited to, 3-glycidoxypropyltrimethoxy silane and 3-aminopropyltrimethoxy silane.

Suitable solvents include, but are not limited to, acetone, methylethyl ketone, tetrahydrofuran, methylene dichloride, chloroform, toluene, xylene, 1-methyl pyrrolidinone, N,N-dimethyl acetamide, N,N-dimethyl foramide, dimethyl sulfoxide, polyphosphoric acid, butyl acetate, water, and mixtures thereof.

When the nanocomposite is to contain small aggregated nanosize spherical particles, the spherical silica, polymer, and solvent may be mixed using high shear mixing, either with or without sonication or ultrasonication. After the high-shear mixing, the solvent is evaporated. The resulting mixture may be ultrasonicated, if desired. Curing agent is added to the resultant mixture, which is degassed and cured.

With the nanocomposite containing the small aggregated nanosize spherical particles, mixing the spherical silica, polymer, and solvent can be accomplished in a variety of ways. The spherical silica can be dispersed in the solvent using high shear mixing, the polymer can be mixed with the solvent, and the spherical silica/solvent mixture and polymer/solvent mixture can be mixed together with high shear mixing. By high shear mixing, we mean mixing with a shear rate of about 8,000 to about 30,000 rpm.

Alternatively, the spherical silica, polymer and solvent may be combined at the same time using high shear mixing. Another method involves dispersing the spherical silica in the solvent with high shear mixing, and adding the polymer (without solvent) with high shear mixing. Still another method involves mixing the spherical silica with the polymer using stir bar mixing for about 2 hours at a temperature of about 60° C., then mixing in the solvent using high shear mixing. The preferred method of combining the components will vary depending on the solubility of the polymer being used.

When the nanocomposite is to contain individual nanosize spherical silica particles, a suspension of spherical silica should be used. The components can be mixed by a combination of stir bar mixing and ultrasonication, low shear mixing and ultrasonication, or high shear mixing. With stir bar mixing, the suspension of spherical silica and the polymer are mixed with a stir bar and ultrasonicated. No additional solvent beyond that present in the suspension of spherical silica particles is needed. The solvent is evaporated and degassed, a curing agent is added, and the resulting mixture is degassed and cured. Alternatively, low shear mixing with ultrasonication can be used. In addition, high shear mixing without ultrasonication can be used when the nanocomposite contains low levels of silica (about 1 wt %).

It may be desirable to include a dispersing agent when mixing the nanosize material with the polymer and solvent to ensure a uniform dispersion of the materials. Suitable dispersing agents for use in the present invention include oils, plasticizers, and various surfactants. Suitable oils include vegetable and mineral oils including, but not limited to, castor oils, modified castor oils, soybean oils, modified soy bean oils, rape seed and canola oils, mineral oils, petroleum greases and lubricants. Suitable plasticizers include adipates, esters, oleates, phthalates, epoxides, and polymeric and monomeric plasticizers commonly used in industrial and specialty applications.

The resulting nanocomposite material may be further processed according to the desired application. For example, the nanocomposite material may be formed into a thin film which is cast from the solution mixture by evaporating the solvent at a temperature which is at or below the boiling point of the solvent. Alternatively, the solvent may be removed by coagulation in which the solution mixture is formed into a film or fiber and then immersed in a nonsolvent, such as water, to coagulate the film. The solution mixture may also be formed into thin films by spin coating and dip coating methods. The solution mixture may also be formed into large components such as thick sheets or panels by spraying or deposition, or by extruding or molding the dried composite material.

The nanocomposite material comprising layered silicates may be formed into structural adhesives, coatings, inks, films, extruded shapes, thick sheets, molded parts, and large structural components.

The use of nanosize materials comprising spherical silica results in polymeric nanocomposite materials having one or more improved properties. It should be understood that there need not be improvement in all properties for a useful composite. The electrical properties of the nanocomposite, including dielectric constant and dielectric nanocapacitance, are unique and can be tailored to specific applications. The nanocomposites have increased mechanical properties, improved durability, and improved abrasion resistance. They also have a reduced coefficient of thermal expansion, increased thermal capabilities, and improved fire retardancy. The nanocomposites have reduced microcracking and outgassing, and reduced permeability. They also mitigate material property dissimilarities across joints. In addition, they have increased property retention in extreme environments such as atomic oxygen in low earth orbital in outer space, and oxygen plasma. Thus, the nanocomposites of the present invention are multifunctional.

In order that the invention may be more readily understood, reference is made to the following examples which are intended to illustrate the invention, but not limit the scope thereof.

### EXAMPLE 1

Samples of spherical silica epoxy nanocomposites and layered silicate epoxy nanocomposites were formed using the method of the present invention in which spherical silica nanoparticles or nanosheets of layered silicate were combined with acetone followed by the addition of an epoxy resin (Epon 862 or Epon 828 from Shell), a curing agent (Jeffamine® from Huntsman Chemical) with or without a coupling agent (3-glycidoxypropyltrimethoxy silane or 3-aminopropyltrimethoxy silane).

The introduction of nanosize spherical silica into the epoxy resin resulted in good dispersion without significant precipitation.

The dispersion of the nanosheets in the epoxy resin matrix was relatively good.

Despite these initial conclusions, additional testing has shown that the spherical silica particles were aggregated, and the silicate nanosheets were stacked together. The layered silicates are intercalated nanocomposites or a mixture of intercalated and partially exfoliated nanocomposites.

Various methods for dispersing spherical silica in the epoxy were evaluated. In the stir-bar mixing method, the epoxy resin and the spherical silica powder were mixed using a stirring bar at elevated temperature (about 60° C.) for about 2 to 4 hours. (The silica particles will be partially precipitated from the mixture overnight.) The mixture was degassed and the stoichiometric amount of curing agent was added. The mixture was degassed and cured in the mold.

### EXAMPLE 2

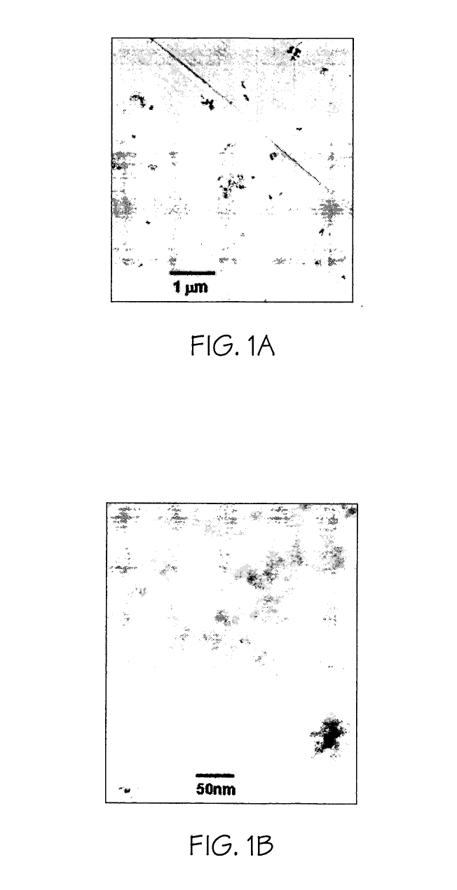

A nanocomposite was made with 1.3% spherical silica (14 nm powder from Aldrich), epoxy resin (Epon 862), and a curing agent (curing agent W (diethyltoluenediamine)). The sample was microtomed, and a TEM image was taken. The TEM images at low and high magnification are shown in FIG. 1. The silica particles were dispersed in the whole epoxy resin matrix. This can be seen easily from the TEM image at low magnification. The size of the individual spherical particles was about 14 nm, which is consistent with the information provided by the silica producer. However, most of the original silica nanoparticles are still aggregated together and the dispersion is not homogeneous. The aggregation dimension is about several hundred nanometers. The large size of the aggregation of the silica nanoparticle is believed to be the reason for the precipitation of the silica/Epon 862 mixture.

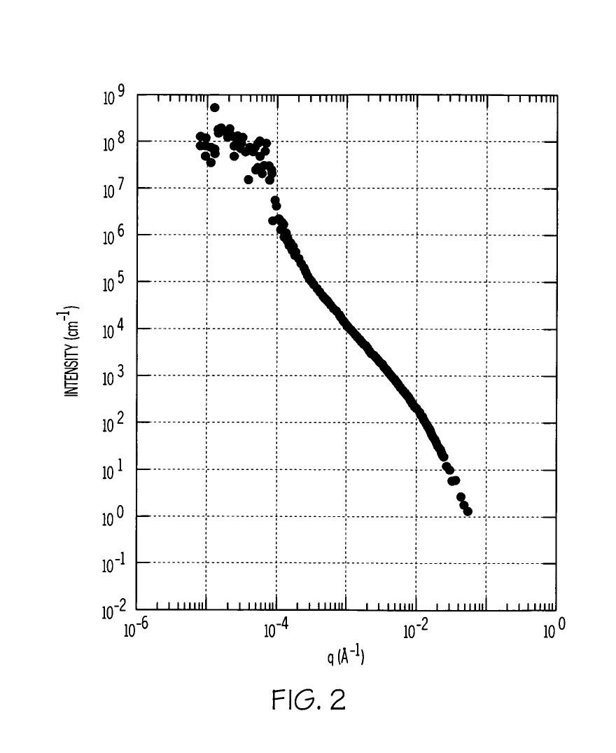

The ultra-small-angle x-ray scattering of this nanocomposite is shown in FIG. 2. The data shows that the dispersion of the nanosilica aggregation is not homogeneous.

Another method which was evaluated used high-shear mixing. In this method, the desired amount of epoxy and the corresponding amount of spherical silica nanoparticle (powder) were mixed using high-shear mixing in the bath sonication for about 3 to 6 hours. After the high-shear mixing, the solvent was evaporated. The epoxy mixture with spherical silica nanoparticle was stable, and no spherical silica was precipitated. (If stir-bar mixing or general mechanical mixing in the sonication bath is applied, the particles will partially precipitate.) However, the mixture looked cloudy. Curing agent was added to the resultant mixture, which was degassed and cured.

### EXAMPLE 3

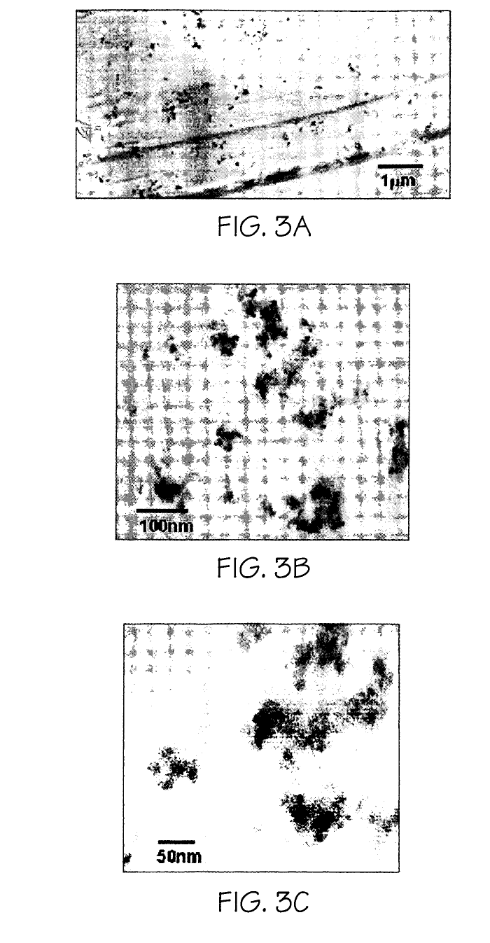

A nanocomposite was made with 1% spherical silica (14 nm powder from Aldrich), epoxy resin (Epon 862), and a curing agent (curing agent W). The sample was microtomed, and a TEM image was taken. The TEM images at low and high magnification are shown in FIG. 3. The silica nanoparticles were relatively well dispersed in the whole epoxy matrix. This can be seen easily from the TEM image at low magnification. The size of the individual spherical particle is about 14 nm, which is consistent with the information provided by the silica producer. However, most of the original silica nanoparticles are still aggregated together. The aggregation dimensions ranged from 50 nm (several individual spherical silica particles) to about 200 nm (tens of 14 nm particles aggregation), with some as large as about 400 nm.

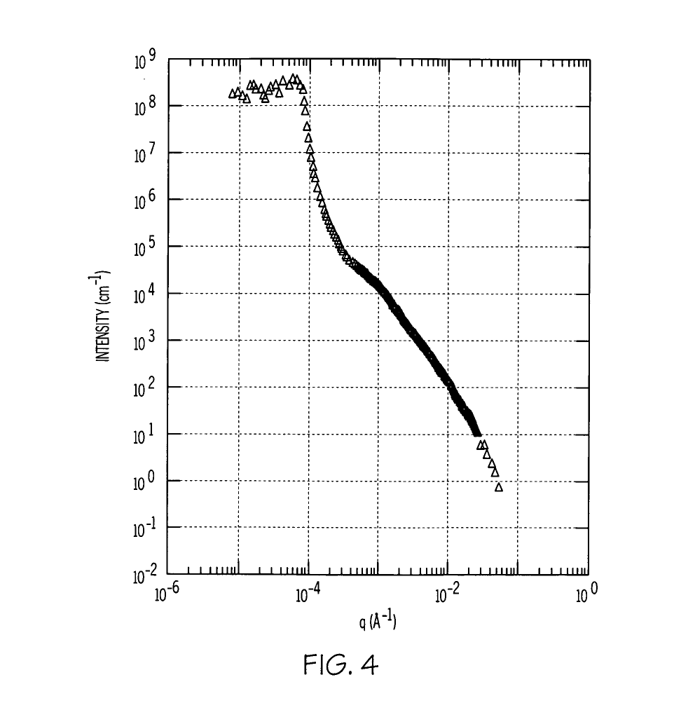

The ultra-small-angle x-ray scattering of this nanocomposite is shown in FIG. 4. The data shows that the dispersion of the nanosilica aggregation is still not very homogeneous, but better than that of Example 2.

Another method for dispersing the spherical silica in the epoxy matrix was high shear mixing with ultrasonication before the addition of the curing agent. In this method, the desired amount of epoxy resin and the corresponding amount of spherical silica nanoparticles were mixed using high-shear mixing in the bath sonication for about 3 to 6 hours. After the solvent (acetone) was evaporated, the resulting mixture was ultrasonicated for about 3 to 6 hours. The epoxy mixture with the spherical nanoparticles was very stable, and no spherical silica was precipitated. The mixture after ultrasonication looked much clearer than before ultrasonication. The stoichiometric amount of curing agent was added to the resultant mixture, which was degassed and cured.

### EXAMPLE 4

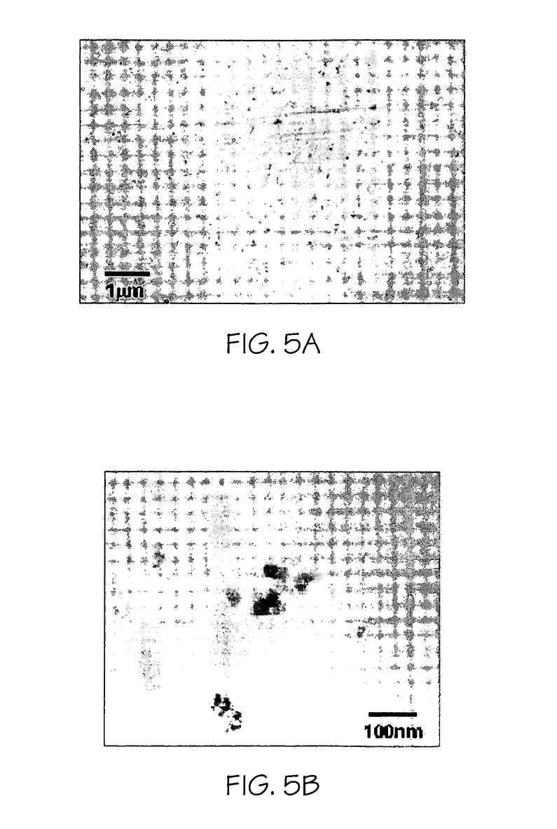

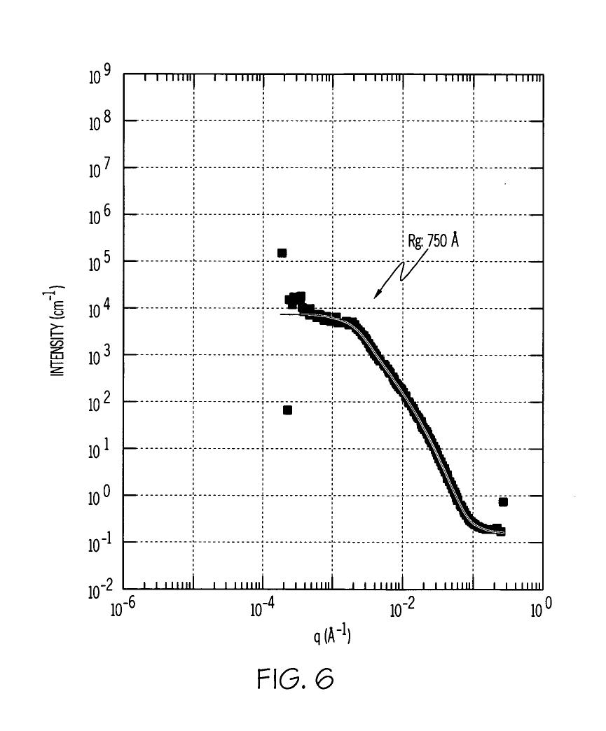

A nanocomposite was made with 1.3% spherical silica (14 nm powder from Aldrich), epoxy resin (Epon 862), and a curing agent (curing agent W). The sample was microtomed, and a TEM image was taken. The TEM images at low magnification and high magnification of the nanocomposite are shown in FIG. 5. The silica nanoparticles were very well dispersed in the whole epoxy matrix. This can be seen clearly from the TEM image at low magnification. The size of the individual spherical particles is about 14 nm, which is consistent with the information provided by the silica producer. Although most of the original silica nanoparticles (14 nm) are still aggregated together, the aggregation dimensions ranged from about 60 nm to about 120 nm (several individual spherical silica particles). Ultra-small-angle x-ray scattering was taken, and is shown in FIG. 6. The data showed the very homogeneous dispersion of spherical silica nanoparticles in the epoxy matrix. Based on the data fitting and analysis, the Guinier radius (Rg, the radius-of-gyration) is 750 Å, which for spherical domains of radius (R) is Rg=(⅗)^{0.5}R. So the particle size was about 100 nm, which is consistent with the results of the TEM studies.

### EXAMPLE 5

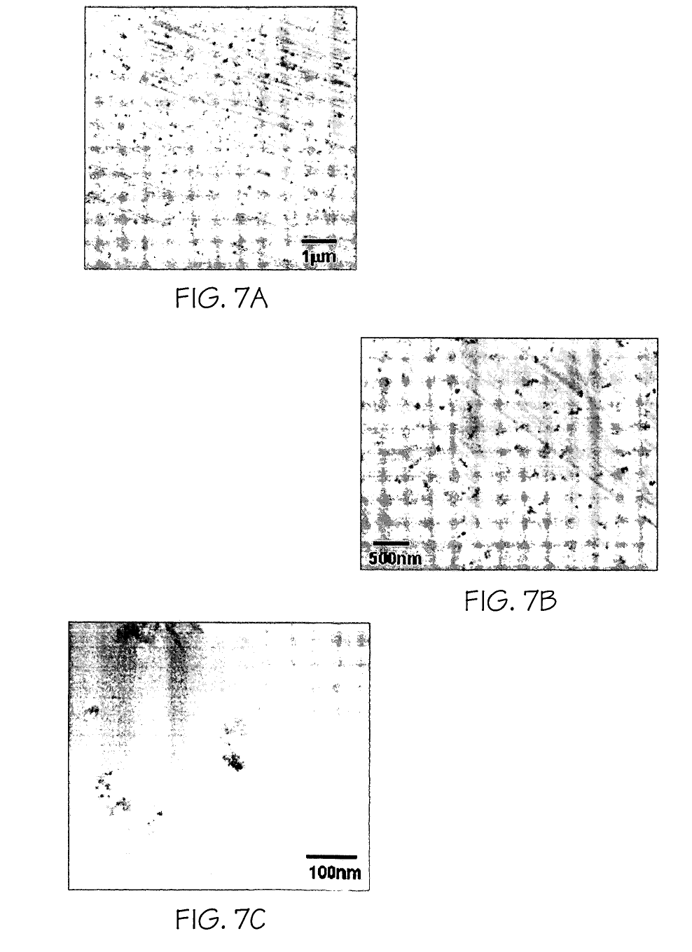

A nanocomposite was made with 1.3% spherical silica (14 nm powder from Aldrich), epoxy resin (Epon 828), and a curing agent (curing agent W). The sample was microtomed, and a TEM image was taken. The TEM images at low magnification and high magnification of the nanocomposite are shown in FIG. 7. The silica nanoparticles were very well dispersed in the whole epoxy matrix. The size of the individual spherical particles is about 14 nm. The aggregation dimensions of each particle in the nanocomposite ranged from about 60 nm to about 120 nm (several individual spherical silica particles).

### EXAMPLE 6

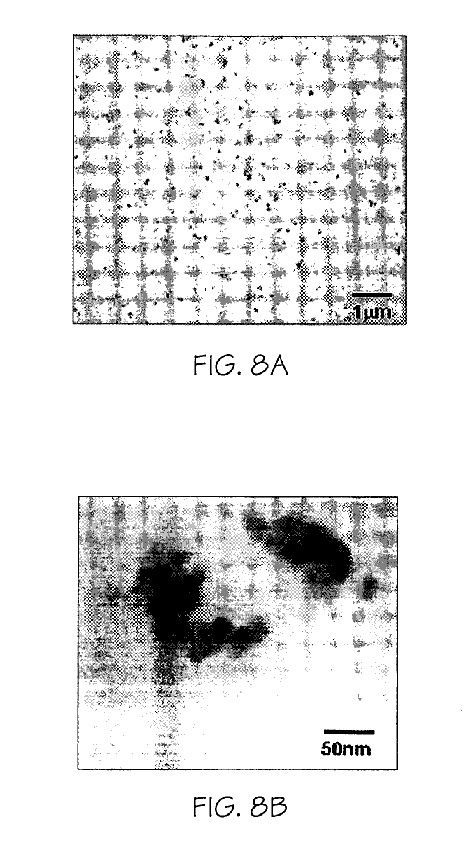

A nanocomposite was made with 1.1% spherical silica (14 nm powder from Aldrich), epoxy resin (Epon 828), and a curing agent (Jeffamine D400). The sample was microtomed, and a TEM image was taken. The TEM images at low magnification and high magnification of the nanocomposite are shown in FIG. 8. The silica nanoparticles were very well dispersed in the whole epoxy matrix. The size of the individual spherical particles is about 14 nm. The aggregation dimensions of each particle in the nanocomposite ranged from about 60 nm to about 120 nm (several individual spherical silica particles).

The use of high shear mixing combined with ultrasonication before the addition of the curing agent produces a homogeneous and continuous dispersion of the spherical silica particles in the epoxy matrix. The silica nanoparticles are in an aggregated state (about 100 nm, 5-10 individual silica particles).

A third method for dispersing the spherical silica in the epoxy matrix involved a combination of stir bar mixing and ultrasonication of a suspension of spherical silica. In this procedure, the suspension of spherical silica and the epoxy resin were mixed with a stir bar and simultaneously ultrasonicated for about 3 to 6 hours. The epoxy mixture with spherical silica nanoparticles was very stable and appeared clear. The mixture was evaporated and degassed, and a curing agent was added. The mixture was then degassed and cured.

### EXAMPLE 7

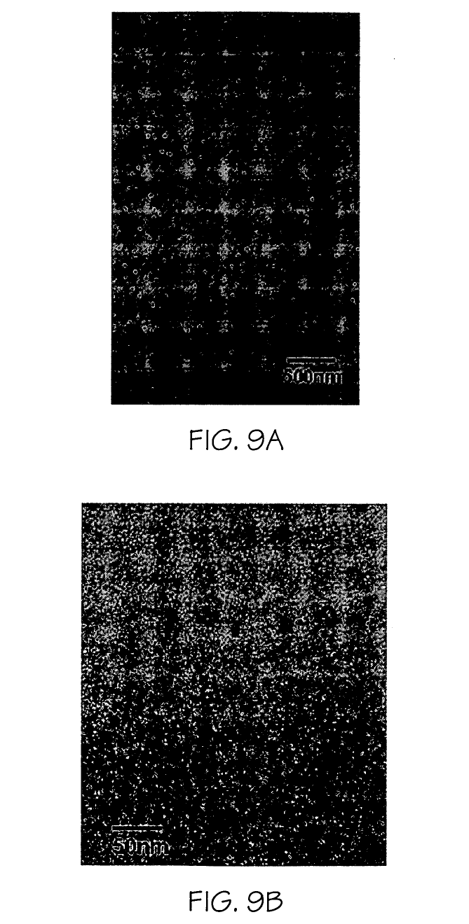

Nanocomposites were made with 1.3%, 5% and 10% of spherical silica nanoparticle MEK-ST (suspension of about 30 wt % silica and about 70 wt % solvent (methylethyl ketone) from Nissan Chemicals), epoxy (Epon 862), and curing agent (curing agent W). The sample was microtomed and TEM images were taken. The TEM images at low magnification and high magnification of the 1.3% silica nanocomposite are shown in FIG. 9. The silica nanoparticle is very well dispersed in the epoxy matrix. There is no aggregation of individual silica in the nanocomposite. The individual silica nanoparticles (about 12 to 15 nm) are homogeneously and continuously dispersed in the whole epoxy matrix. This is the spherical silica epoxy nanocomposite with perfect morphology

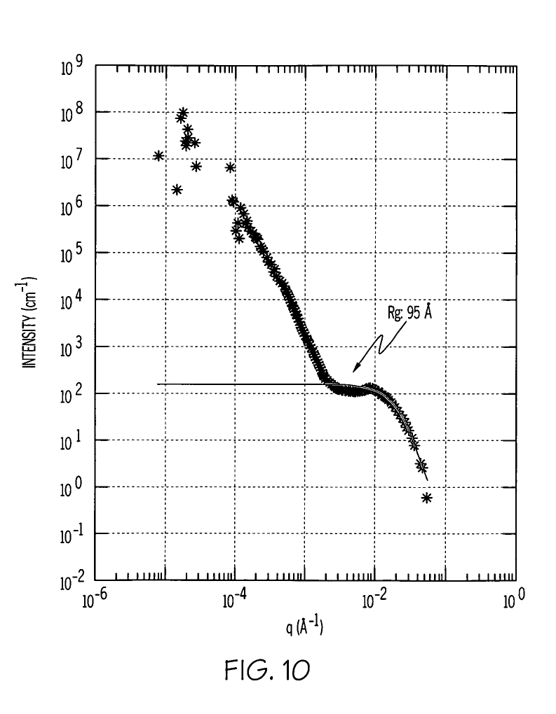

The ultra-small-angle x-ray scattering of this nanocomposite is shown in FIG. 10. The data shows that the dispersion of the nanosilica aggregation is very homogeneous with the size of the individual silica particles, about 12.5 nm (Rg: ˜95 Å). The ultra-small-angle x-ray scattering data is very well consistent with the TEM image.

In summary, the morphology of the dispersion of spherical silica nanoparticle in the epoxy matrix can be controlled. The homogeneous and continuous dispersion of the silica nanoparticle in the polymer matrix can be achieved for silica nanoparticles with aggregation states in the size of ˜100 nm (Examples 4, 5, and 6), and for individual silica nanoparticles with the size of 12 nm (Example 7) using the methods disclosed.

It will be obvious to those skilled in the art that various changes may be made without departing from the scope of the invention which is not to be considered limited to what is described in the specification.

1. A method of making a nanocomposite having individual nanosize spherical silica particles therein comprising:
providing a suspension of nanosize spherical silica particles in solvent;
combining the suspension of nanosize spherical silica particles and a polymer to form a substantially homogeneous mixture;
removing the solvent from the mixture;
adding a curing agent to the mixture; and
curing the mixture to form the nanocomposite, wherein the nanocomposite comprises the individual nanosize spherical silica particles dispersed in the polymer.

2. The method of claim 1 wherein the polymer comprises a thermosetting polymer.

3. The method of claim 1 wherein the curing agent is selected from amines, anhydrides, or combinations thereof.

4. The method of claim 1 further comprising adding an accelerator to the mixture.

5. The method of claim 1 further comprising adding solvent to the mixture.

6. The method of claim 1 wherein the solvent is removed by evaporation.

7. The method of claim 1 in which the solvent is selected from acetone, methylethyl ketone, tetrahydrofuran, methylene dichloride, chloroform, toluene, xylene, 1-methyl pyrrolidinone, N,N-dimethyl acetamide, N,N-dimethyl foramide, dimethyl sulfoxide, polyphosphoric acid, butyl acetate, water, or mixtures thereof.

8. The method of claim 1 further comprising adding a dispersing agent when combining the nanosize spherical silica particles and polymer.

9. The method of claim 1 further comprising adding a coupling agent.

10. The method of claim 9 wherein the coupling agent comprises 3-glycidoxypropyltrimethoxy silane, 3-aminopropyltrimethyoxy silane.

11. The method of claim 1 wherein the substantially homogeneous mixture is formed by a process selected from stir bar mixing with ultrasonication, low shear mixing with ultrasonication, or high shear mixing.

12. A method of making a nanocomposite having nanosize spherical silica particles, the method comprising:
providing nanosize spherical silica particles;
combining the nanosize spherical silica particles and a polymer with solvent using high shear mixing to form a substantially homogeneous mixture;
removing the solvent from the mixture;
adding a curing agent to the mixture; and
curing the mixture to form the nanocomposite, wherein the nanocomposite comprises small aggregated nanosize spherical silica particles dispersed in the polymer.

13. The method of claim 12 wherein the nanosize spherical silica particles are combined with solvent before the polymer is added.

14. The method of claim 12 wherein the polymer is combined with solvent before the nanosize spherical silica particles are added.

15. The method of claim 12 wherein providing nanosize spherical silica particles comprises providing a suspension of nanosized spherical silica particles in solvent.

16. The method of claim 12 wherein the polymer comprises a thermosetting polymer.

17. The method of claim 12 wherein the solvent is selected from acetone, methylethyl ketone, tetrahydrofuran, methylene dichloride, chloroform, toluene, xylene, 1-methyl pyrrolidinone, N,N-dimethyl acetamide, N,N-dimethyl foramide, dimethyl sulfoxide, polyphosphoric acid, butyl acetate, water, or mixtures thereof.

18. The method of claim 12 wherein the solvent is removed by evaporation.

19. The method of claim 12 further comprising adding a dispersing agent when combining the nanosize spherical silica particles and polymer.

20. The method of claim 12 further comprising adding a coupling agent to the mixture.

21. The nanocomposite made by the method of claim 1.

22. The nanocomposite made by the method of claim 12.
